(19) United States
(12) Patent Application Publication
(10) Pub. No.: US 2007/0147084 A1
(43) Pub. Date: Jun. 28, 2007

(54) Backlight module for liquid crystal display device

(75) Inventor: Feng-Li Lin, Taishan Township (TW)

Correspondence Address: BIRCH STEWART KOLASCH & BIRCH, PO BOX 747, FALLS CHURCH, VA, 22040-0747, US

(73) Assignee: GIGNO TECHNOLOGY CO., LTD.

(21) Appl. No.: 11/643,669

(22) Filed: Dec. 22, 2006

(30) Foreign Application Priority Data
Dec. 23, 2005 (TW) 094146037

(51) Int. Cl. F21V 7/04

(52) U.S. Cl. 362/613

(57) ABSTRACT

A backlight module for a liquid crystal display (LCE) device includes at least one light source and a light adjusting unit. The light source has at least one first light emitting diode (LED) and at least one second LED. When the first LED is turned on, the second LED turns on for a first time period and senses lighting intensity of the first LED for a second time period to generate a sensing signal. The light adjusting unit electrically connected to the first LED and the second LED receives the sensing signal to adjust the lighting intensity of the first LED.

### BACKGROUND OF THE INVENTION

1. Field of Invention

The invention relates to a backlight module, and, in particular, to a backlight module for a liquid crystal display device.

2. Related Art

Because liquid crystal displays (LCDs) are compact, they are a favorite among consumers. The conventional LCD device mainly includes a liquid crystal display panel and a backlight module that provides a light source of the LCD device and a cold cathode fluorescent lamp (CCFL) serves as the light source. However, because light emitting diodes (LEDs) have higher efficiency than the CCFL, some manufacturers have replaced the CCFL with LEDs as the light source of the backlight module of the LCD device.

The conventional LED backlight module includes a plurality of LEDs composed of red light diodes, green light diodes and blue light diodes. Because the lighting intensity of the LED tends to be influenced by the manufacturing processes and temperature and tends to attenuate with elapsed time of use. Also, because the degrees of attenuation of the LEDs are not completely the same, the LCD device may develop a color shift problem according to the change in temperature and elapsed time of use when the LCD device has LEDs serving as the light source of the backlight module.

Thus, it is an important subject of the invention to provide a backlight module of the LCD device capable of sensing the lighting intensity of the LEDs in the backlight module and adjusting the lighting intensity of the LEDs according to the conditions thereof so as to control the lighting intensity of the backlight module precisely.

### SUMMARY OF THE INVENTION

In view of the foregoing, the invention is to provide a backlight module for a LCD device, which can prevent color shift by adjusting the lighting intensity.

To achieve the above, a backlight module for the LCD device according to the invention includes at least one light source and a light adjusting unit, wherein the light source has at least one first LED and at least one second LED. When the first LED is turned on, the second LED turns on for a first time period and senses the lighting intensity of the first LED for a second time period to generate a sensing signal. The light adjusting unit electrically connected to the first LED and the second LED receives the sensing signal to adjust the lighting intensity of the first LED according to the sensing signal.

In addition, a backlight module for the LCD device according to the invention includes at least one light source and a light adjusting unit, wherein the light source has at least one first LED and at least one second LED. When the first LED is turned on, the second LED turns off for a first time period and senses the lighting intensity of the first LED for a second time period to generate a sensing signal. The light adjusting unit electrically connected to the first LED and the second LED receives the sensing signal to adjust the lighting intensity of the first LED according to the sensing signal.

As mentioned above, the second LED senses the lighting intensity of the first LED in the backlight module for the LCD device of the invention, and the light adjusting unit adjusts the lighting intensity of the first LED according to the sensed result. Thus, the lighting intensity of the first LED can be adjusted according to its condition, and the brightness of the backlight module can be precisely controlled.

### BRIEF DESCRIPTION OF THE DRAWINGS

The invention will become more fully understood from the detailed description given herein below illustration only, and thus is not limitative of the present invention, and wherein:

FIG. 1 is a schematic illustration showing a backlight module for a LCD device according to a preferred embodiment of the invention;

FIGS. 2 and 3 show timing charts in the backlight module for the LCD device according to the preferred embodiment of the invention;

FIG. 4 is another schematic illustration showing the backlight module for the LCD device according to the preferred embodiment of the invention;

FIG. 5 shows another timing chart in the backlight module for the LCD device according to the preferred embodiment of the invention;

FIG. 6 is still another schematic illustration showing the backlight module for the LCD device according to the preferred embodiment of the invention;

FIG. 7 shows still another timing chart in the backlight module for the LCD device according to the preferred embodiment of the invention;

FIG. 8 is yet another schematic illustration showing the backlight module for the LCD device according to the preferred embodiment of the invention; and

FIG. 9 shows yet still another timing chart in the backlight module for the LCD device according to another preferred embodiment of the invention.

### DETAILED DESCRIPTION OF THE INVENTION

The present invention will be apparent from the following detailed description, which proceeds with reference to the accompanying drawings, wherein the same references relate to the same elements.

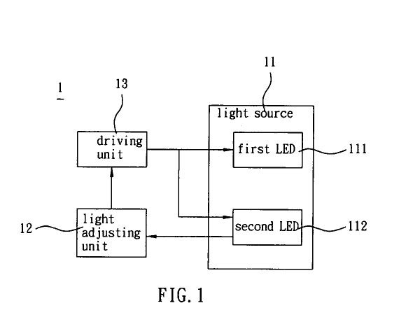

Referring to FIG. 1, a backlight module 1 for the LCD device according to the preferred embodiment of the invention includes a light source 11, a light adjusting unit 12 and a driving unit 13. In this embodiment, the light source 11 includes a first light emitting diode (LED) 111 and a second LED 112. The driving unit 13 is electrically connected to the first LED 111 and the second LED 112 and drives the first LED 111 and the second LED 112 to turn on the first LED 111 and the second LED 112 simultaneously or unsimultaneously.

As mentioned hereinabove, in order to make the LCD device display various colors, the light source 11 may be a red light source, a green light source, a blue light source, or a white light source. In order to realize the four-color light source 11, the first LED 111 may be a red light diode, a green light diode, a blue light diode or a white light diode, and the second LED 112 may be a red light diode, a green light diode, a blue light diode or a white light diode.

In addition, regarding the structure of the LED, the first LED 111 may be an organic light emitting diode or a stacked organic light emitting diode, and the second LED 112 may be an organic light emitter diode or a stacked organic light emitter diode.

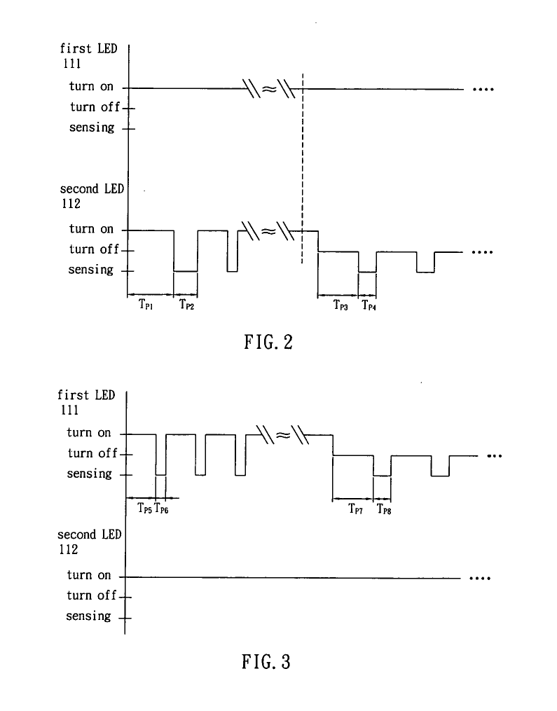

As shown in FIG. 2, when the first LED 111 is turned on, the second LED 112 turns on for a time period Tₚ₁ and senses the lighting intensity of the first LED 111 in a time period Tₚ₂ to generate a sensing signal S. The light adjusting unit 12 is electrically connected to the first LED 111 and the second LED 112 and receives the sensing signal S to adjust the lighting intensity of the first LED 111 according to the sensing signal S.

In addition, when the first LED is turned on, the second LED may also turn off for a time period Tₚ₃ and sense the lighting intensity of the first LED in a time period Tₚ₄ to generate the sensing signal S. When the second LED either turns on or turns off, the sensing mode may be switched to sense the lighting intensity of the first LED while lit so that the light adjusting unit 12 can adjust the lighting intensity of the first LED 111.

Furthermore, as shown in FIG. 3, this embodiment may also be modified into the aspect that the first LED senses the lighting intensity of the second LED. In the time periods Tₚ₅, Tₚ₆, Tₚ₇ and Tₚ₈, the second LED 112 is turned on, the first LED 111 turns on for the time period Tₚ₅ and senses the lighting intensity of the second LED 112 in the time period Tₚ₆ to generate the sensing signal S, and the light adjusting unit 12 receives the sensing signal S and adjusts the lighting intensity of the second LED 112 according to the sensing signal S. In addition, the first LED may also turn off for the time period Tₚ₇ and sense the lighting intensity of the second LED for the time period Tₚ₈ to generate the sensing signal S. Thus, when the first LED either turns on or turns off, the sensing mode can be switched to sense the lighting intensity of the second LED while lit so that the light adjusting unit 12 can adjust the lighting intensity of the second LED 112.

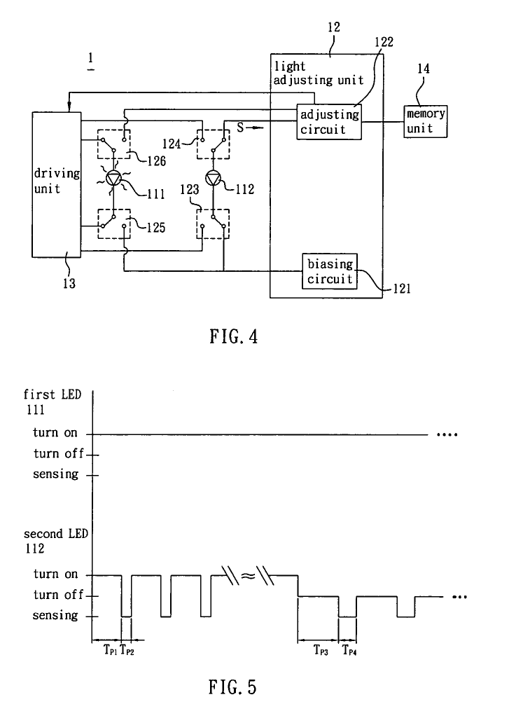

As shown in FIG. 4, the backlight module 1 further includes a memory unit 14, and the light adjusting unit 12 includes a biasing circuit 121, an adjusting circuit 122 and four switches 123 to 126.

As shown in FIGS. 4 and 5, the driving unit 13 is electrically connected to the first LED 111 through the switches 125 and 126, and drives the first LED 111 to turn on, and the driving unit 13 is electrically connected to the second LED 112 through the switches 123 and 124 in the time period Tₚ₁, and drives the second LED 112 to turn on. In the time period Tₚ₂, the biasing circuit 121 is electrically connected to one end of the second LED 112 through the switch 123, and the adjusting circuit 122 is electrically connected to the other end of the second LED 112 through the switch 124. Thus, a reverse bias voltage V generated by the biasing circuit 121 can drive the second LED 112 to sense the lighting intensity of the first LED 111, and the second LED 112 can thus generate the sensing signal S.

In addition, the driving unit 13 may be electrically connected to the second LED 112 through the switches 123 and 124 but does not drive the second LED 112 to turn on for the time period Tₚ₃. Then, in the time period Tₚ₄, the second LED 112 is electrically connected to the biasing circuit 121 and the adjusting circuit 122 to generate the sensing signal S.

The light adjusting unit 12 receives the sensing signal S to judge whether the lighting intensity of the first LED 111 reaches a predetermined lighting intensity. If the judged result is negative, the light adjusting unit 12 adjusts the driving current generated by the driving unit 13 to drive the first LED 111 more strongly so that the lighting intensity of the first LED 111 reaches the predetermined lighting intensity. In this embodiment, the second LED 112 can periodically sense the lighting intensity of the first LED 111 to generate the sensing signal S so that the lighting intensity of the first LED 111 may be periodically monitored. It is to be specified that the light adjusting unit 12 can process the operations of this embodiment according to, but not limited to, a digital manner.

In addition, the predetermined lighting intensity may be recorded as a predefined value, and the driving unit 13 drives the first LED 111 to turn on according to the predefined value. When the user adjusts the brightness of the LCD device or the brightness of the backlight module has to be adjusted, this predefined value is reset so that the lighting intensity of the first LED 111 can be adjusted.

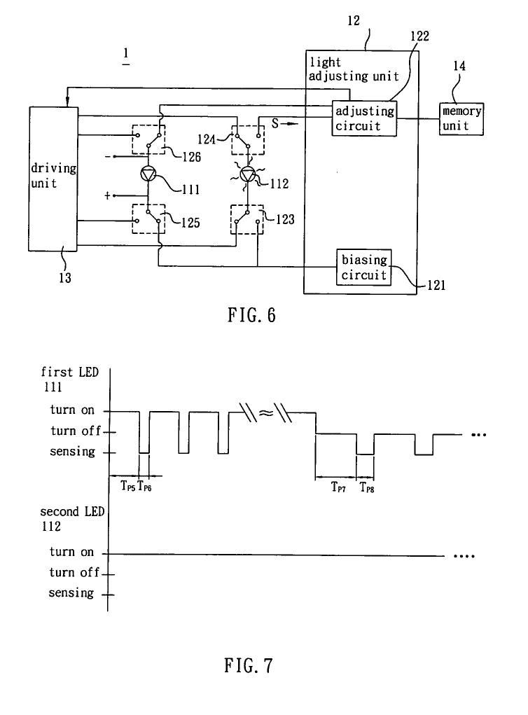

As shown in FIGS. 6 and 7, the driving unit 13 is electrically connected to the second LED 112 to drive the second LED 112 to turn on through the switches 123 and 124 in order to control the lighting intensity of the first LED 111 and the second LED 112 effectively. In addition, the driving unit 13 is electrically connected to the first LED 111 through the switches 125 and 126 in the time period Tₚ₅. In the time period Tₚ₆, the biasing circuit 121 may be electrically connected to one end of the first LED 111 through the switch 125, and the adjusting circuit 122 is electrically connected to the other end of the first LED 111 through the switch 126. Thus, the reverse bias voltage V generated by the biasing circuit 121 can drive the first LED 111 to sense the lighting intensity of the second LED 112, and the first LED 111 may thus generate the sensing signal S. Consequently, the adjusting circuit 122 may receive the sensing signal S to adjust the lighting intensity of the second LED 112. In addition, the adjusting circuit 122 may also adjust the lighting intensity of the second LED 112 according to the sensing signal S.

In addition, the driving unit 13 may be electrically connected to the first LED 111 through the switches 125 and 126 but not drive the first LED 111 to turn on for the time period Tₚ₇. Then, the first LED 111 is electrically connected to the biasing circuit 121 and the adjusting circuit 122 so that the sensing signal S is generated in the time period Tₚ₈. The first LED 111 can periodically sense the lighting intensity of the second LED 112 to generate the sensing signal S so that the lighting intensity of the second LED 112 can be periodically monitored.

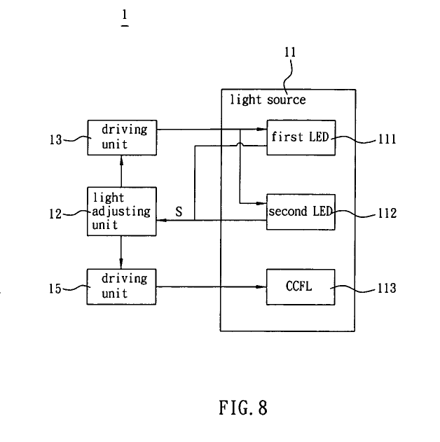

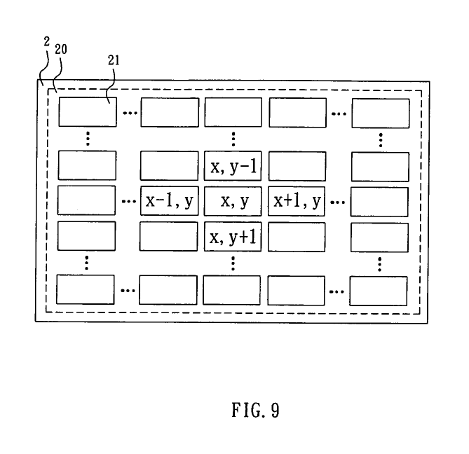

Referring to FIG. 8, the backlight module 1 further includes a driving unit 15, and the light source 11 further includes at least one CCFL 113. The driving unit 15 drives the CCFL 113 to turn on, and the first LED 111 or the second LED 112 senses the lighting intensity or chroma of the CCFL 113 to generate the sensing signal S. Thus, the light adjusting unit 12 can receive the sensing signal S and adjust the driving current of the driving unit 15 for driving the CCFL 113 so as to adjust the lighting intensity of the CCFL 113. In addition, the light adjusting unit 12 may also adjust the driving current for driving the first LED 111 or the second LED 112 so as to adjust the brightness of the backlight module 1.

Of course, the above-mentioned embodiment is described by taking the light source including two LEDs as an example. In practice, however, the light source may include a plurality of LEDs. The method of sensing and adjusting the lighting intensity of these LEDs will be described in the following embodiment.

Referring to FIG. 9, a backlight module 2 for the LCD device according to this embodiment includes a light source 20, which includes a plurality of LEDs 21. The driving unit drives the LEDs 21 to turn on. When the (x−1,y)^{th} LED 21 turns on, the (x,y)^{th} LED is electrically connected to the light adjusting unit, the (x,y)^{th} LED senses the lighting intensity of the (x−1,y)^{th} LED to generate a sensing signal, and the light adjusting unit controls the driving unit for adjustment according to the sensing signal. In order to make the sensed result more accurate, the (x,y−1)^{th}, (x,y+1)^{th} and (x+1,y)^{th} LEDs 21 beside the (x,y)^{th} LED may turn off, and the (x,y)^{th} LED can solely sense the lighting intensity of the (x−1,y)^{th} LED. The light adjusting unit can adjust each LED 21 according to this adjusting method so as to compensate for the attenuation of the lighting intensity of each LED 21 and thus to eliminate the color shift problem of the LED 21.

In summary, the second LED senses the lighting intensity of the first LED in the backlight module for the LCD device of the invention, and the light adjusting unit adjusts the lighting intensity of the first LED according to the sensed result. Thus, the lighting intensity of the first LED can be adjusted according to its condition, and the brightness of the backlight module can be precisely controlled.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A backlight module for a LCD device, the backlight module comprising:
at least one light source comprising at least one first light emitting diode (LED) and at least one second LED, wherein when the first LED is turned on, the second LED turns on for a first time period and senses lighting intensity of the first LED for a second time period to generate a sensing signal; and
a light adjusting unit, which is electrically connected to the first LED and the second LED and receives the sensing signal to adjust the lighting intensity of the first LED.

2. The module according to claim 1, wherein the light source is a red light source, a green light source, a blue light source or a white light source.

3. The module according to claim 1, wherein the first LED is a red light diode, a green light diode, a blue light diode or a white light diode.

4. The module according to claim 1, wherein the second LED is a red light diode, a green light diode, a blue light diode or a white light diode.

5. The module according to claim 1, wherein the first LED is an organic light emitting diode or a stacked organic light emitting diode.

6. The module according to claim 1, wherein the second LED is an organic light emitting diode or a stacked organic light emitting diode.

7. The module according to claim 1, wherein the second LED periodically senses the lighting intensity of the first LED to generate the sensing signal.

8. The module according to claim 1, further comprising:
a memory unit for storing default lighting intensity of the light source.

9. The module according to claim 8, wherein the light adjusting unit adjusts the lighting intensity of the first LED and the second LED according to the default lighting intensity.

10. The module according to claim 1, wherein the light adjusting unit comprises:
a biasing circuit, which is electrically connected to the second LED and generates and outputs a reverse bias voltage to the second LED so that the second LED senses the lighting intensity of the first LED to generate the sensing signal.

11. The module according to claim 1, further comprising:
a driving unit electrically connected to the light adjusting unit for driving the first LED and the second LED.

12. The module according to claim 1, wherein the light source further comprises at least one CCFL.

13. The module according to claim 12, wherein the second LED senses lighting intensity or chroma of the CCFL to generate the sensing signal.

14. The module according to claim 13, wherein the light adjusting unit further adjusts the lighting intensity of the CCFL.

15. A backlight module for a LCD device, the module comprising:
at least one light source comprising at least one first LED and at least one second LED, wherein when the first LED is turned on, the second LED turns off for a first time period and senses lighting intensity of the first LED in a second time period to generate a sensing signal; and
a light adjusting unit, which is electrically connected to the first LED and the second LED and receives the sensing signal to adjust the lighting intensity of the first LED.

16. The module according to claim 15, wherein the light source is a red light source, a green light source, a blue light source or a white light source.

17. The module according to claim 15, wherein the first LED is a red light diode, a green light diode, a blue light diode or a white light diode.

18. The module according to claim 15, wherein the second LED is a red light diode, a green light diode, a blue light diode or a white light diode.

19. The module according to claim 15, wherein the first LED is an organic light emitting diode or a stacked organic light emitting diode.

20. The module according to claim 1, wherein the second LED is an organic light emitting diode or a stacked organic light emitting diode.

21. The module according to claim 15, wherein the second LED periodically senses the lighting intensity of the first LED to generate the sensing signal.

22. The module according to claim 15, further comprising:
a memory unit for storing default lighting intensity of the light source.

23. The module according to claim 22, wherein the light adjusting unit adjusts the lighting intensity of the first LED and the second LED according to the default lighting intensity.

24. The module according to claim 15, wherein the light adjusting unit comprises:
a biasing circuit, which is electrically connected to the second LED and generates and outputs a reverse bias voltage to the second LED so that the second LED senses the lighting intensity of the first LED to generate the sensing signal.

25. The module according to claim 15, further comprising:
a driving unit electrically connected to the light adjusting unit for driving the first LED and the second LED.

26. The module according to claim 15, wherein the light source further comprises at least one CCFL.

27. The module according to claim 26, wherein the second LED senses lighting intensity or chroma of the CCFL to generate the sensing signal.

28. The module according to claim 26, wherein the light adjusting unit further adjusts the lighting intensity of the CCFL.
